(19) United States
(12) Patent Application Publication
(10) Pub. No.: US 2024/0122360 A1
(43) Pub. Date: Apr. 18, 2024

(54) Portable Heated Massage Bed Assembly

(71) Applicant: Darion Burks, East Cleveland, OH (US)

(72) Inventor: Darion Burks, East Cleveland, OH (US)

(21) Appl. No.: 17/964,860

(22) Filed: Oct. 12, 2022

(51) Int. Cl. A47C 21/00; A47C 17/72; A47C 17/80; A47C 21/04; A61H 1/00

(52) U.S. Cl. CPC A47C 21/006; A47C 17/72; A47C 17/80; A47C 21/048; A61H 1/005; A61H 2201/0146; A61H 2201/0157; A61H 2201/0207; A61H 2201/0228; A61H 2201/5025; A61H 2201/5043

(57) ABSTRACT

A portable heated massage bed assembly for heating and massaging the user includes a right frame and a left frame being attached together by a pair of hinges. The pair of hinges positions the right frame and the left frame in an open and closed position. A pair of bases is positioned upon a respective one of the right frame and the left frame. A plurality of heating coils is positioned upon a respective one of each of the bases. A pair of mattresses is positioned upon a respective one of each of the bases. Furthermore, a plurality of massaging units is integrated within the pair of mattresses. A pair of mattress covers enwrapping a respective one of the pair of mattresses. A control panel is connected with the plurality of heating coils and the plurality of massaging units. Additionally, a pair of stands supports the left and right frames.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to portable cot device and more particularly pertains to a new portable cot device for heating and massaging the user.

### (2) Description of Related Art Including Information Disclosed Under 37 CFR 1.97 and 1.98

The prior art relates to portable cot device. The prior art relates to a variety of portable cot devices being configured for positioning from an open position to a closed position. Known prior art lacks a portable cot device having a plurality of heating coils and a plurality of massaging units to facilitate in reposing the user when the portable cot device is in an open position.

### BRIEF SUMMARY OF THE INVENTION

An embodiment of the disclosure meets the needs presented above by generally comprising a right frame having a pair of lateral beams and a pair of side beams. The right frame has a top surface and a bottom surface. Furthermore, a left frame has the pair of lateral beams and the pair of side beams as well. In addition, the left frame has a top surface and a bottom surface. A first side beam of the pair of side beams of the left frame is coupled to a first side beam of the pair of side beams of the right frame by a pair of hinges. The pair of hinges is configured for positioning the right frame and the left frame in an open and a closed position relative to each other. A pair of bases is positioned upon a respective one of the top surface of the right frame and the left frame. A plurality of heating coils is positioned upon a respective one of each of the bases. A pair of mattresses is positioned upon a respective one of each of the bases. Each of the mattresses is configured for being compressible wherein facilitating in reposing the user. Furthermore, a plurality of massaging units is integrated within the pair of mattresses. A pair of mattress covers enwrapping a respective one of the pair of mattresses. A control panel is in electric communication with the plurality of heating coils and the plurality of massaging units. Additionally, a pair of stands has a pair of legs configured for supporting the left and right frames.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a portable heated massage bed assembly according to an embodiment of the disclosure.

FIG. 2 is an exploded view of an embodiment of the disclosure.

FIG. 3 is a side view of an embodiment of the disclosure.

FIG. 4 is a folded view of an embodiment of the disclosure.

FIG. 5 is a detail isometric view of an embodiment of the disclosure.

FIG. 6 is a top in-use view of an embodiment of the disclosure.

FIG. 7 is a cross-sectional front in-use view of an embodiment of the disclosure.

FIG. 8 is a side in-use view of an embodiment of the disclosure.

### DETAILED DESCRIPTION OF THE INVENTION

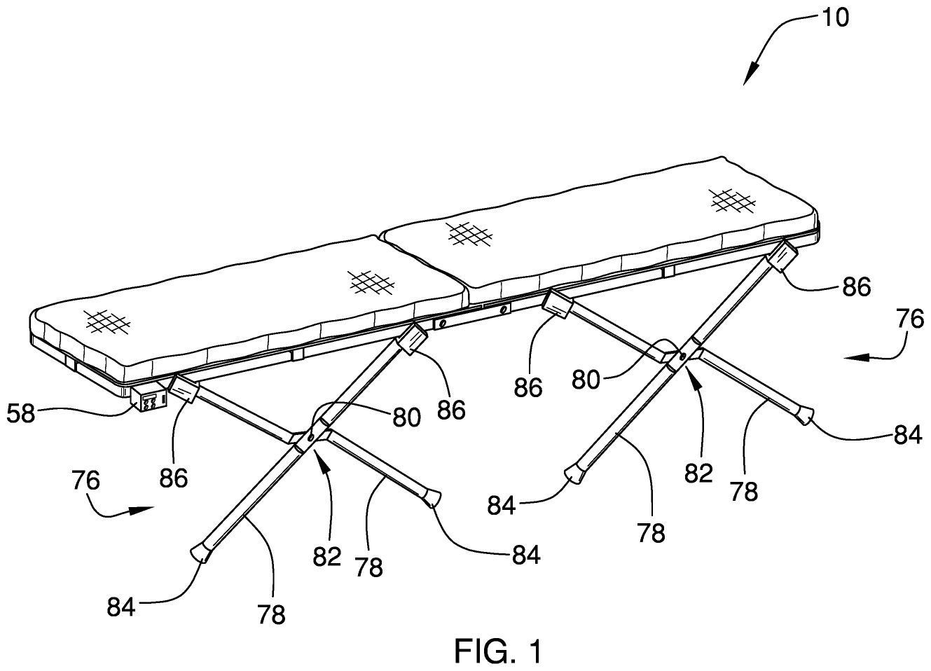

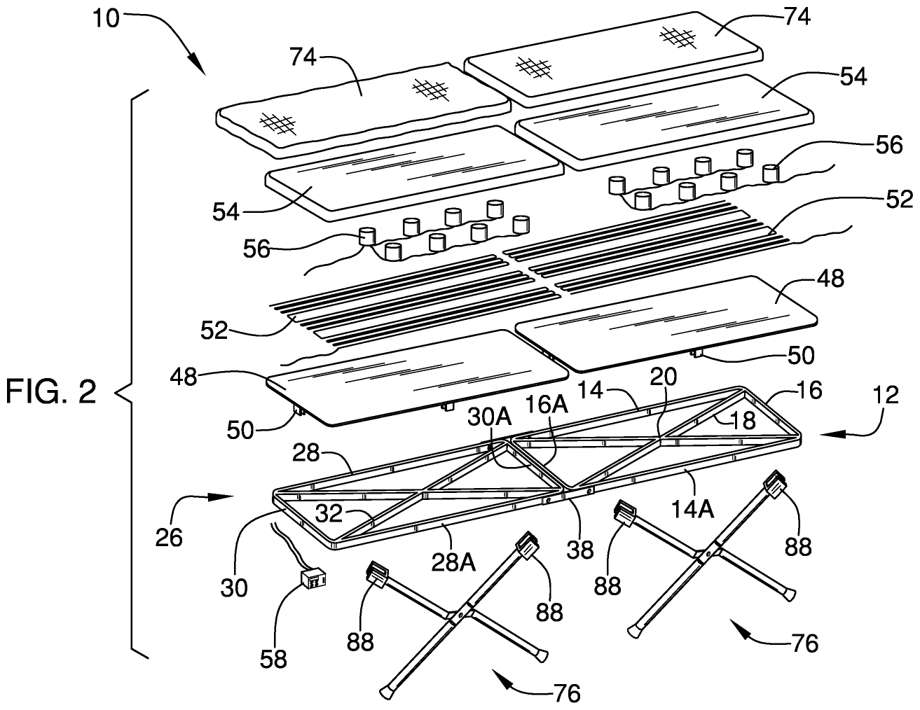

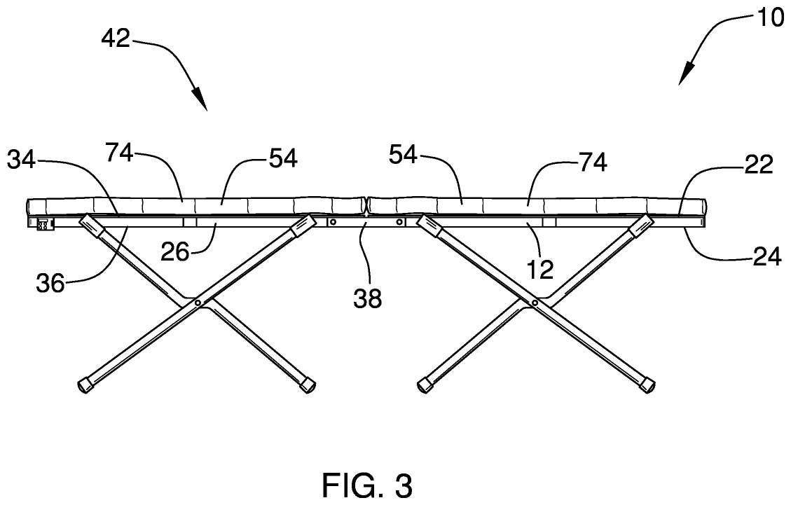

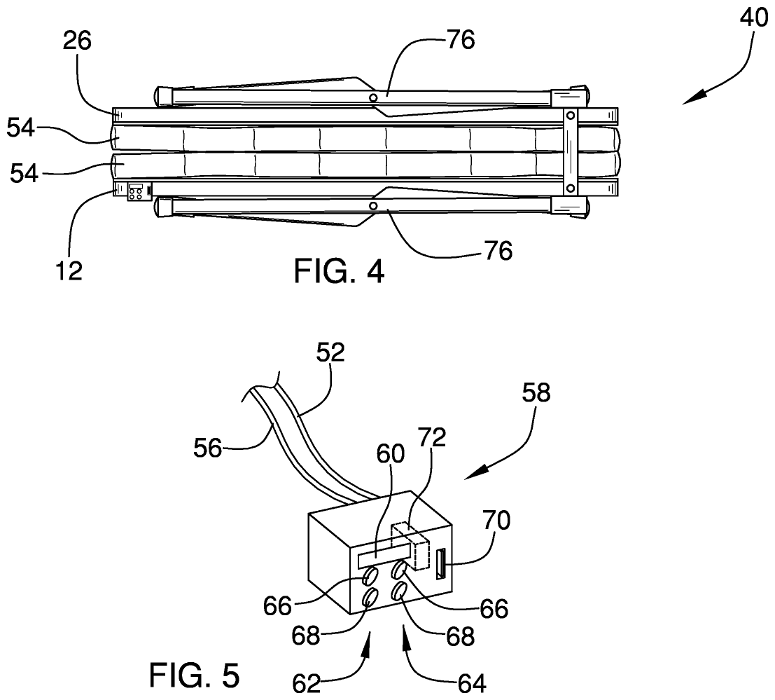

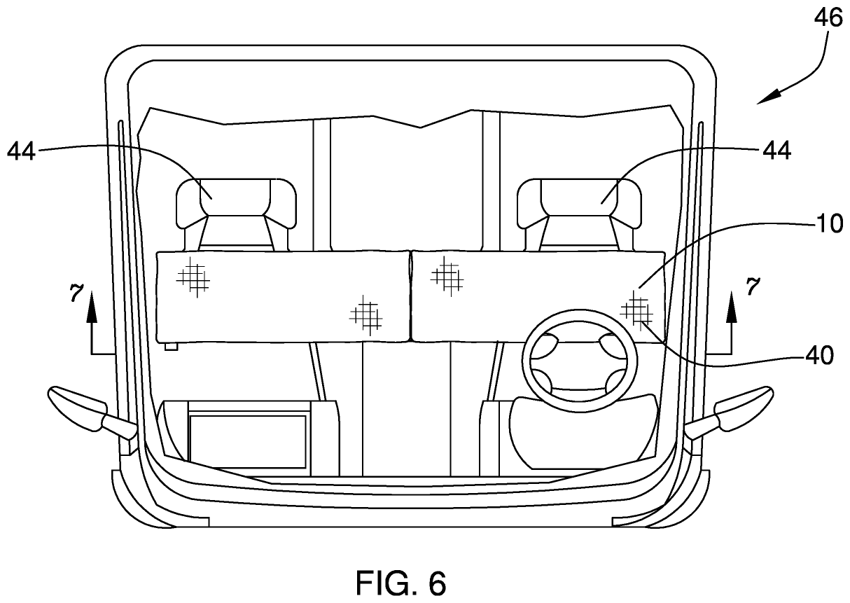

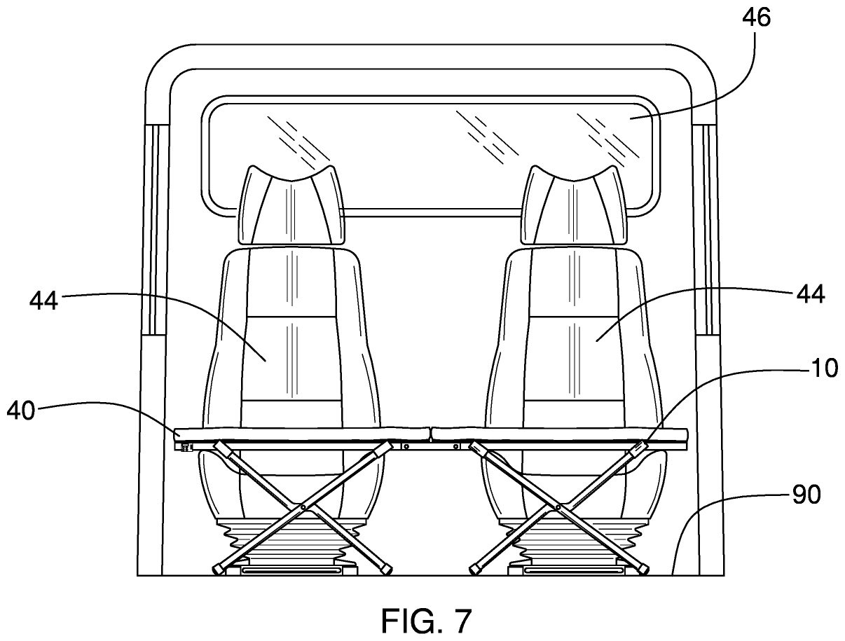

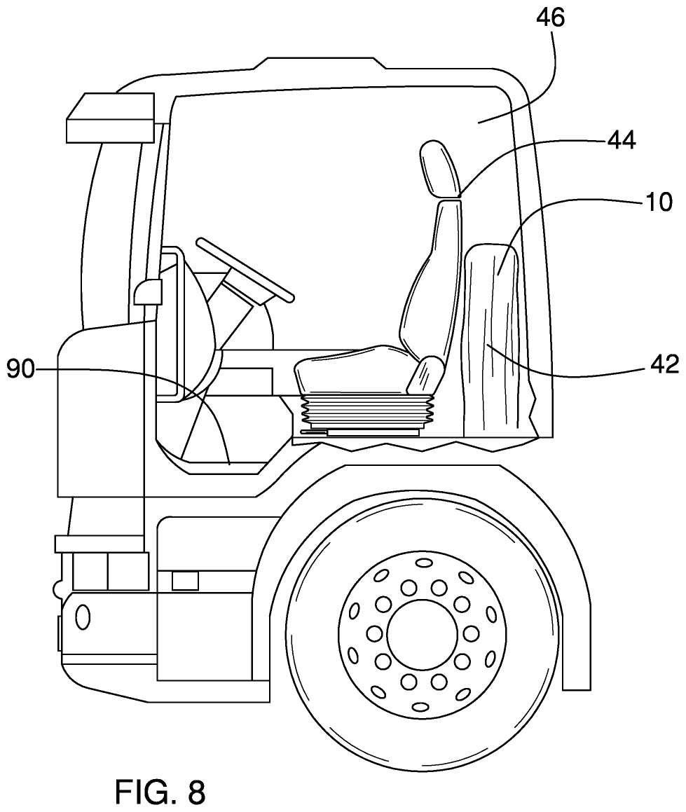

With reference now to the drawings, and in particular to FIGS. 1 through 8 thereof, a new portable cot device embodying the principles and concepts of an embodiment of the disclosure and generally designated by the reference numeral 10 will be described.

As best illustrated in FIGS. 1 through 8, the portable heated massage bed assembly 10 generally comprises a right frame 12 having a pair of lateral beams 14 and a pair of side beams 16. The pair of lateral beams 14 is positioned parallel relative to each other. Furthermore, the pair of lateral beams 14 is positioned perpendicular relative to the pair of side beams 16. The right frame 12 has a pair of center beams 18 wherein each of the center beams 18 intersect each other in a middle 20 of each of the center beams 18. The pair of center beams 18 is configured for providing support to the right frame 12. Additionally, the right frame 12 has a top surface 22 and a bottom surface 24.

A left frame 26 has a pair of lateral beams 28 and a pair of side beams 30. In addition, the left frame 26 has a pair of center beams 32 similar to the right frame 12. The left frame 26 has a top surface 34 and a bottom surface 36 as well. A first side beam 30A of the pair of side beams 30 of the left frame 26 is coupled to a first side beam 16A of the pair of side beams 16 of the right frame 12 by a pair of hinges 38. The pair of hinges 38 is configured for positioning the right frame 12 and the left frame 26 in an open position 40 and a closed position 42 relative to each other. The open position 40 is configured for the right frame 12 and the left frame 26 being coplanar to each other. The closed position 42 is configured for the left frame 26 and the right frame 12 abutting each other. The open position 40 is configured for the bottom surface 24 of the right frame 12 and the bottom surface 36 of the left frame 26 to rest upon a pair of seats 44 within a day cab 46. Furthermore, the closed position 42 is configured for being stored behind the pair of seats 44 within the day cab 46.

A pair of bases 48 is positioned upon a respective one of the top surface 22 of the right frame 12 and the top surface 34 of the left frame 26. Each of the bases 48 has a rectangular shape that covers the entire top surface 22 of the right frame 12 and entire top surface 34 of the left frame 26. Each of the bases 48 has a plurality of clips 50. Each of the clips 50 is configured for latching to a respective one of the pair of lateral beams 14 and the pair of side beams 16 of the right frame 12 and a respective one of the pair of lateral beams 28 and pair of side beams 30 of the left frame 26. The plurality of clips 50 of each of the bases 48 is configured for making the plurality of bases 48 removable from the right 12 and left 26 frames.

A plurality of heating coils 52 is positioned upon a respective one of each of the bases 48. Each of the heating coils 52 is configured for producing heat wherein reposing the user. A pair of mattresses 54 is positioned upon a respective one of each of the bases 48 with the plurality of heating coils 52 being position between the pair of mattresses 54 and the pair of bases 48. Each of the mattresses 54 is configured for being compressible wherein facilitating in reposing the user. The pair of mattresses 54 is configured for evenly distributing the heat from the plurality of heating coils 52.

A plurality of massaging units 56 is integrated within the pair of mattresses 54. Each of the massaging units 56 is configured for vibrating within a range of frequencies to soothe the body of the user. Each of the massaging units 56 is in electric communication with each other wherein the plurality of massaging units 56 operates in a synchronized system. A control panel 58 is in electric communication with the plurality of heating coils 52 and the plurality of massaging units 56. The control panel 58 has a display 60 for the user to see the status of operation of the plurality of heating coils 52 and the plurality of massaging units 56.

The control panel 58 has a heat actuator 62 and a massage actuator 64, wherein the heat 62 and massage 64 actuators each is a pair of buttons. The pair of buttons of the heat 62 and massage 64 actuators include an increase button 66 and a decrease button 68. The increase button 66 increases the amperage of the plurality of heating coils 52 and of the plurality of massaging units 56. Alternately, the decrease button 68 reduces the amperage. The control panel 58 has a universal serial bus port 70 configured for providing power to a battery 72 of the control panel 58. The universal serial bus port 70 can also be used to provide electric charge to a universal serial bus input inserted within the universal serial bus port 70.

A pair of mattress covers 74 enwraps a respective one of the pair of mattresses 54. Each of the mattress covers 74 couples each of the mattresses 54 to a respective one of each of the bases 48 by an elastic band wherein retaining each of the mattresses 54 in a fixed position relative to each of the bases 48. Each of the mattress covers 74 is a supple material configured for being elastic to stretch across each of the bases 48. Additionally, each of the mattress covers 74 is removable and washable.

A pair of stands 76 having a pair of legs 78 is configured for supporting the left 26 and right 12 frames. Each of the legs 75 of each of the stands 76 is coupled to each other by a pivot joint 80 in a center 82 of each of the legs 78. Each of the legs 78 of each of the stands 76 has a foot end 84 and a frame end 86. The frame end 86 of each of the legs 78 has a slot 88 configured for being nested around a first lateral beam 28A of the pair of lateral beams 28 of the left frame 26 and a first lateral beam 14A of the pair of lateral beams 14 of the right frame 12 wherein retaining each of the stands 76 to the left 26 and right 12 frames. The foot end 84 of each of the legs 78 is configured for being positioned upon a floor 90 of a day cab 46 of a semi truck to retain the left 26 and the right 12 frames in a fixed position upon the pair of seats 44 of the day cab 46.

In use, the portable heated massage bed assembly 10 is positioned in an open position 40. The bottom surface 36 of the left frame 26 and the bottom surface 24 of the right frame 12 are positioned upon the pair of seats 44 of the day cab 46. The pair of stands 76 is attached to the left 26 and right 12 frames to provide support to the portable heated massage bed assembly 10. The user can actuate either the plurality of heating coils 52 or the plurality of massaging units 56 by engaging with the heat actuator 62 and the massage actuator 64. When complete, the user positions the portable heated massage bed assembly 10 in a closed position 42 and stores the portable heated massage bed assembly behind the pair of seats 44 of the day cab 46.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A portable heated massage bed assembly configured to be used in a day cab of a semi truck, the portable heated massage bed assembly comprising:
a right frame having a pair of lateral beams and a pair of side beams, said right frame having a top surface and a bottom surface;
a left frame having a pair of lateral beams and a pair of side beams, said left frame having a top surface and a bottom surface, a first side beam of said pair of side beams of said left frame being coupled to a first side beam of said pair of side beams of said right frame by a pair of hinges, said pair of hinges being configured for positioning said right frame and said left frame in an open and a closed position relative to each other;
a pair of bases being positioned upon a respective one of said top surface of said right frame and said top surface of said left frame;
a plurality of heating coils being positioned upon a respective one of each of said bases;
a pair of mattresses being positioned upon a respective one of each of said bases, each of said mattresses being configured for being compressible wherein facilitating in reposing the user;
a plurality of massaging units being integrated within said pair of mattresses;
a pair of mattress covers enwrapping a respective one of said pair of mattresses;
a control panel being in electric communication with said plurality of heating coils and said plurality of massaging units; and
a pair of stands having a pair of legs configured for supporting said left and right frames.

2. The portable heated massage bed assembly of claim 1, further comprising said pair of lateral beams being positioned parallel relative to each other, said pair of lateral beams being positioned perpendicular relative to said pair of side beams.

3. The portable heated massage bed assembly of claim 2, further comprising said right frame having a pair of center beams, each of said center beams intersecting each other in a middle of each of said center beams, said pair of center beams being configured for providing support to said right frame.

4. The portable heated massage bed assembly of claim 3, further comprising said left frame has said pair of center beams.

5. The portable heated massage bed assembly of claim 4, further comprising said open position being configured for said right frame and said left frame being coplanar to each other, said closed positioned being configured for said left frame and said right frame abutting each other.

6. The portable heated massage bed assembly of claim 5, further comprising said open position being configured for said bottom surface of said right and said bottom surface of left frame resting upon a pair of seats within a day cab, said closed position being configured for being stored behind said pair of seats within the day cab.

7. The portable heated massage bed assembly of claim 5, further comprising each of said bases having a rectangular shape, each of said bases having a plurality of clips, each of said clips being configured for latching to a respective one of said pair of lateral beams and said pair of side beams of said right frame and a respective one of said pair of lateral beams and pair of side beams of said left frame.

8. The portable heated massage bed assembly of claim 1, further comprising each of said heating coils being configured for producing heat wherein reposing the user.

9. The portable heated massage bed assembly of claim 8, further comprising said plurality of heating coils being position between said pair of mattresses and said pair of bases, each of said mattresses being configured for being compressible wherein facilitating in reposing the user, said pair of mattresses being configured for evenly distributing the heat from said plurality of heating coils.

10. The portable heated massage bed assembly of claim 9, further comprising each of said massaging units being configured for vibrating within a range of frequencies to soothe the body of the user, each of said massaging units being in electric communication with each other.

11. The portable heated massage bed assembly of claim 10, further comprising each of said mattress covers coupling each of said mattresses to a respective one of each of said bases by an elastic band wherein retaining each of said mattresses in a fixed position relative to each of said bases.

12. The portable heated massage bed assembly of claim 11, further comprising each of the mattress covers being a supple material configured for being elastic to stretch across each of said bases, each of said mattress covers being removable and washable.

13. The portable heated massage bed assembly of claim 12, further comprising said control panel having a display, said control panel having a heat actuator and a massage actuator, said heat and massage actuators being a pair of buttons, said control panel having a universal serial bus port configured for providing power to said control panel.

14. The portable heated massage bed assembly of claim 1, further comprising each of said legs of each of said stands being coupled to each other by a pivot joint in a center of each of said legs, each of said legs of each of said stands having a foot end and a frame end, said frame end of each of said legs having a slot configured for being nested around a first lateral beam of said pair of lateral beams of said frame wherein retaining each of said stands to said frame, said foot end of each of said legs being configured for being positioned upon a floor of a day cab of a semi truck.

15. A portable heated massage bed assembly configured to be used in a day cab of a semi truck, the portable heated massage bed assembly comprising:
a right frame having a pair of lateral beams and a pair of side beams, said pair of lateral beams being positioned parallel relative to each other, said pair of lateral beams being positioned perpendicular relative to said pair of side beams, said right frame having a pair of center beams, each of said center beams intersecting each other in a middle of each of said center beams, said pair of center beams being configured for providing support to said right frame, said right frame having a top surface and a bottom surface;
a left frame having a pair of lateral beams and a pair of side beams, said left frame has a pair of center beams, said left frame having a top surface and a bottom surface, a first side beam of said pair of side beams of said left frame being coupled to a first side beam of said pair of side beams of said right frame by a pair of hinges, said pair of hinges being configured for positioning said right frame and said left frame in an open and a closed position relative to each other, said open position being configured for said right frame and said left frame being coplanar to each other, said closed positioned being configured for said left frame and said right frame abutting each other, said open position being configured for said bottom surface of said right and said bottom surface of left frame resting upon a pair of seats within a day cab, said closed position being configured for being stored behind said pair of seats within the day cab;
a pair of bases being positioned upon a respective one of said top surface of said right frame and said top surface of said left frame, each of said bases having a rectangular shape, each of said bases having a plurality of clips, each of said clips being configured for latching to a respective one of said pair of lateral beams and said pair of side beams of said right frame and a respective one of said pair of lateral beams and pair of side beams of said left frame;
a plurality of heating coils being positioned upon a respective one of each of said bases, each of said heating coils being configured for producing heat wherein reposing the user;
a pair of mattresses being positioned upon a respective one of each of said bases, said plurality of heating coils being position between said pair of mattresses and said pair of bases, each of said mattresses being configured for being compressible wherein facilitating in reposing the user, said pair of mattresses being configured for evenly distributing the heat from said plurality of heating coils;
a plurality of massaging units being integrated within said pair of mattresses, each of said massaging units being configured for vibrating within a range of frequencies to soothe the body of the user, each of said massaging units being in electric communication with each other;
a pair of mattress covers enwrapping a respective one of said pair of mattresses, each of said mattress covers coupling each of said mattresses to a respective one of each of said bases by an elastic band wherein retaining each of said mattresses in a fixed position relative to each of said bases, each of the mattress covers being a supple material configured for being elastic to stretch across each of said bases, each of said mattress covers being removable and washable;
a control panel being in electric communication with said plurality of heating coils and said plurality of massaging units, said control panel having a display, said control panel having a heat actuator and a massage actuator, said heat and massage actuators being a pair of buttons, said control panel having a universal serial bus port configured for providing power to said control panel; and
a pair of stands having a pair of legs configured for supporting said left and right frames, each of said legs of each of said stands being coupled to each other by a pivot joint in a center of each of said legs, each of said legs of each of said stands having a foot end and a frame end, said frame end of each of said legs having a slot configured for being nested around a first lateral beam of said pair of lateral beams of said left frame and a first lateral beam of said pair of lateral beams of said right frame wherein retaining each of said stands to said left and right frames, said foot end of each of said legs being configured for being positioned upon a floor of a day cab of a semi truck.
